(19) United States
(12) Patent Application Publication
(10) Pub. No.: US 2011/0195160 A1
(43) Pub. Date: Aug. 11, 2011

(54) Multiple Sweet

(76) Inventors: Pablo FERNANDEZ ATELA, Madrid (ES); Andres TRUJILLANO MARTINEZ-BORDIU, Madrid (ES)

(21) Appl. No.: 13/013,126

(22) Filed: Jan. 25, 2011

(30) Foreign Application Priority Data
Feb. 11, 2010 (ES) U201030120

(51) Int. Cl. A23G 3/54

(52) U.S. Cl. 426/103

(57) ABSTRACT

A multiple sweet of simple constitution, allows the grouping of sweet portions that are independent from each other, in the minimum space possible. This allows sharing the sweet with more than one consumer. The existence of sweet portions that are independent from each other permits the combining of tastes and colours. The multiple sweet of the invention comprises sweet portions that are independent from each other, arranged one on top of the other in an adjacent manner, presenting each sweet portion a bar by using a handle partially housed in a corresponding hole provided in each sweet portion.

### CROSS REFERENCE TO RELATED APPLICATIONS

This application claims priority of ES Application No. U201030120 filed Feb. 11, 2010, which is incorporated by reference herein in its entirety.

### DESCRIPTIVE MEMORY

### Object of the invention

The present invention refers to a multiple sweet that allows the consumption thereof in several stages, or better said, to share the sweet among more consumers, given that it comprises the grouping of sweet portions that are independent from each other.

### BACKGROUND OF THE INVENTION

The great variety of sweets, both in their shape, colour or taste, that can be found today is well known.

In particular, the sweets formed by a body of sweet and a stick acting as a handle for the same are very well known.

However, none of the sweets known by the applicant considers the existence of an invention that has the characteristics described in the present specification.

### DESCRIPTION OF THE INVENTION

The multiple sweet object of the present invention contributes a number of advantages that will become obvious from the description attached below.

The sweet of the invention, of simple constitution, allows the grouping of sweet portions that are independent from each other, in the minimum space possible. This allows to consume the sweet several times, or better said, to share the sweet with more than one consumer.

In the same way, the existence of sweet portions that are independent from each other allows to combine tastes and colours.

For this, and more precisely, the multiple sweet of the invention comprises sweet portions that are independent from each other, arranged one on top of the other in an adjacent manner, presenting each sweet portion a bar by way of handle partially housed in a corresponding hole provided in each sweet portion, being interiorly hollow at least the bars corresponding to the portions located below the uppermost portion such that the bars associated to each portion can pass through the inside of the corresponding bar associated to the sweet portion located below the adjacent portion located immediately above it.

It is understood that the characteristics described and below defined in the set of claims are embodied considering that the multiple sweet is arranged in a position for consumption.

In addition, it is understood that the term sweet is extended to any product of confectionery such as, for example, chocolates.

According to the characteristics described, the height of the bar associated to the sweet portion located superiorly to the bar associated to the adjacent portion located immediately below is at least the height of the sweet portion/s and their corresponding bar/s located immediately below.

According to a preferential, although non-limiting characteristic, the sweet portions have a substantially cylindrical shape of constant diameter.

Likewise, the hole present in each of the sweet portions is located centrally, wherein the hole of the sweet portion located uppermost is blind, and the hole of the sweet portions located below the uppermost sweet portion is a traversing hole.

Advantageously, and by virtue of the characteristics of the invention described, a multiple sweet is obtained that groups sweet portions that are independent from each other such that it allows consumption of the sweet in several stages or to share the sweet with more than one consumer.

Also, by using a simple configuration, groupings of sweet portions having different colours and tastes can be provided.

To complement the description given below, and with an aim to aid in the better understanding of its characteristics, attached to the present descriptive memory is a set of designs the figures of which, in an illustrative and non-limiting manner, represent the most significant details of the invention.

### BRIEF DESCRIPTION OF THE DESIGNS

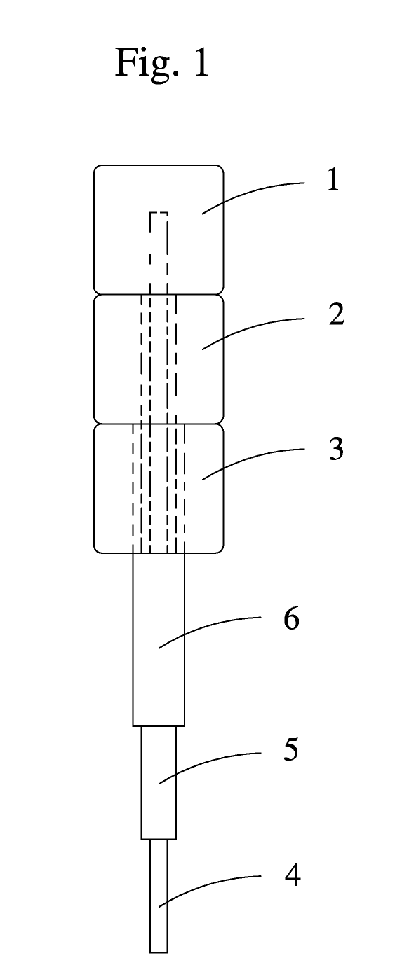

FIG. 1.—Elevated view of the multiple sweet according to the characteristics of the invention.

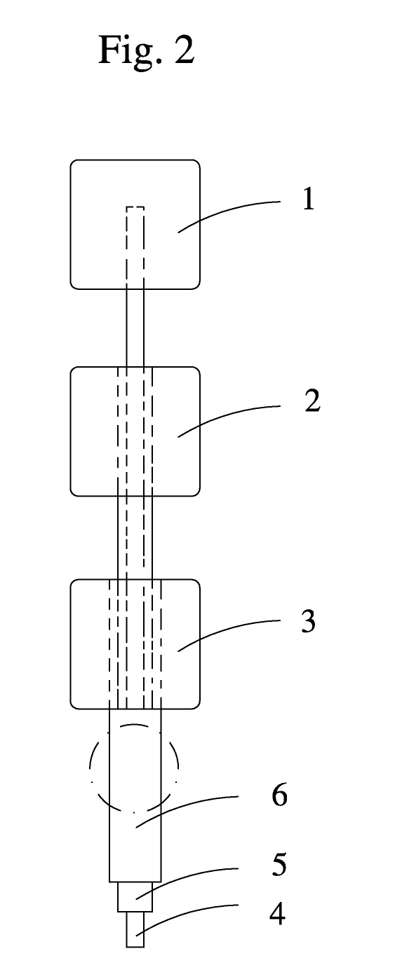

FIG. 2.—Exploded view of the multiple sweet shown in the figure above.

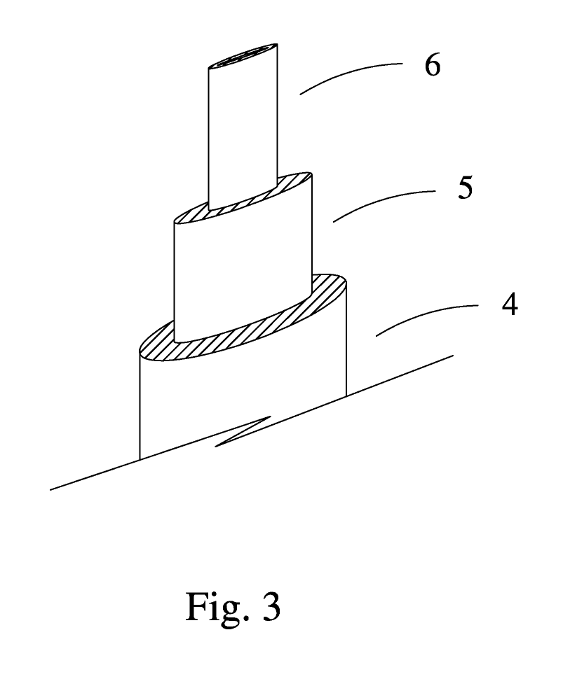

FIG. 3.—Detailed view of the bars of the sweet shown in the figures above.

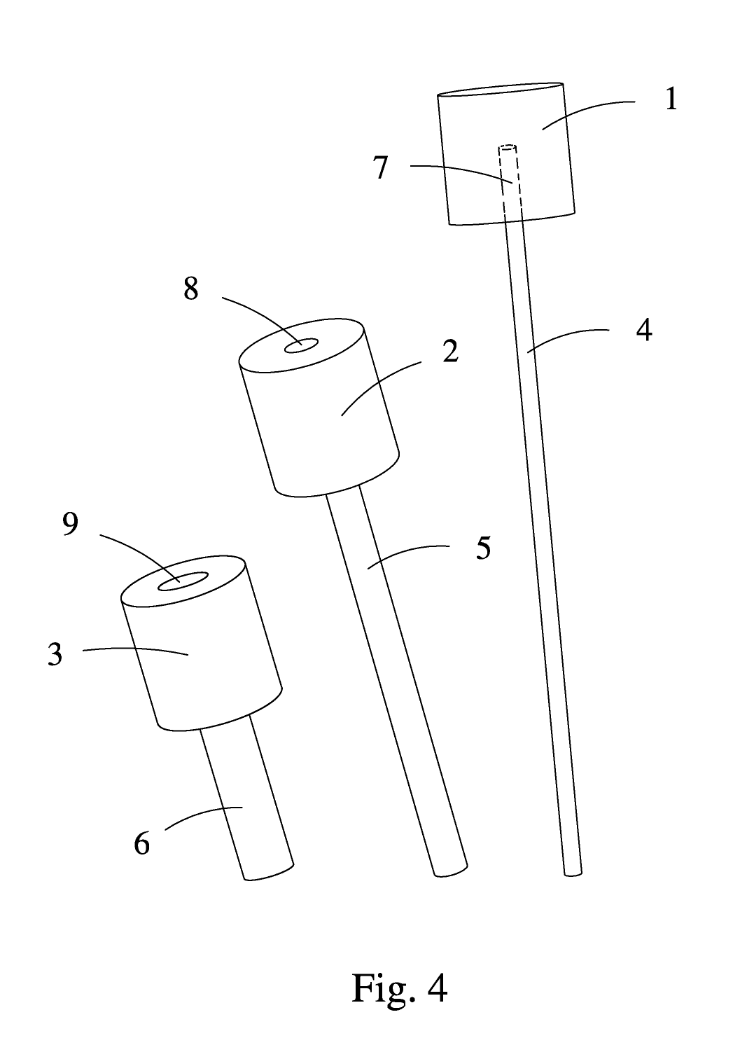

FIG. 4.—Perspective view of the sweet portions, associated to their corresponding bars, arranged independently from each other.

### DESCRIPTION OF A PREFERRED EMBODIMENT

In view of the figures discussed and according to the numbering used, a preferred, although non-limiting embodiment of the invention is shown consisting of a multiple sweet.

As shown in FIGS. 1, 2, 3 and 4, the multiple sweet of the invention comprises three sweet portions (1, 2 and 3) that are independent from each other, arranged one on top of the other in an adjacent manner, each sweet portion (1, 2 and 3) having a bar (4, 5 and 6) by way of handles partially housed in a corresponding hole (7, 8 and 9) provided in each sweet portion (1, 2 and 3), being interiorly hollow at least the two bars (5 and 6) corresponding to the two sweet portions (2 and 3) located below the uppermost sweet portion (1) such that the bars associated to each sweet portion can pass through the inside of the corresponding bar associated to the sweet portion located below the adjacent portion located above it.

According to the characteristics described, the height of the bar (4) associated to the sweet portion (1) located above the bar (5) associated to the adjacent sweet portion (2) located immediately below is larger than the height of the sweet portion (2) and its corresponding bar (5).

The relationship described is maintained between the remaining sweet portions (2 and 3) and their corresponding bars (5 and 6).

As can be seen in FIGS. 1 and 2, the sweet portions (1, 2 and 3) have a cylindrical shape of constant diameter. Also, each sweet portion has a taste and colour that are different from those of the rest of sweet portions.

FIGS. 2 and 4 show the holes (7, 8 and 9) of the sweet portions (1, 2 and 3) are located centrally. More precisely, the hole (7) of the sweet portion (1) located uppermost is blind, while the holes of the sweet portions (2 and 3) located below the uppermost sweet portion (1) are traversing holes.

FIG. 3 shows a detail section of the arrangement of the bars of the multiple sweet shown in FIG. 2. More precisely, it can be seen the bars (4, 5 and 6) associated to each sweet portion (1, 2 and 3) can pass through the inside of the corresponding bar associated to the sweet portion located immediately below the adjacent portion located above it.

According to this last characteristic of the bars (4, 5 and 6), the material they are made of is polypropylene.

Advantageously, and by virtue of the characteristics described, a multiple sweet is obtained that allows the consumption of the sweet in several stages, or to share the same with more than one consumer.

The details, shapes, dimensions and other accessory elements, as well as the materials used in the manufacturing of the multiple sweet of the invention can be conveniently substituted by other technical equivalents without departing from the essentiality nor scope of the invention as defined by the following claims.

1. Multiple sweet, comprising sweet portions that are independent from each other, arranged one on top of the other in an adjacent manner, presenting each of the sweet portions a bar by way of handles partially housed in a corresponding hole provided in each sweet portion, being interiorly hollow at least the bars corresponding to the portions located below the uppermost portion, such that the bars associated to each portion can pass through the inside of the corresponding bar associated to the sweet portion located below the adjacent portion located above it.

2. Multiple sweet, according to claim 1, wherein each of the sweet portions has a substantially cylindrical shape.

3. Multiple sweet, according to claim 2, wherein each of the sweet portions has the same diameter.

4. Multiple sweet, according to claim 1, wherein the height of the bar associated to the sweet portion located above the bar associated to the adjacent portion located immediately below is at least the height of the sweet portion/s and their corresponding bar/s located immediately below.

5. Multiple sweet, according to claim 1, wherein the hole in each of the sweet portions is located centrally.

6. Multiple sweet, according to claim 1, wherein the hole of the uppermost sweet portion is blind.

7. Multiple sweet, according to claim 1, wherein the hole of the sweet portions located below the uppermost sweet portion is a traversing hole.

8. Multiple sweet, according to claim 1, wherein the material of the bars associated to each sweet portion is polypropylene.
